(19) United States
(12) Patent Application Publication
(10) Pub. No.: US 2005/0084593 A1
(43) Pub. Date: Apr. 21, 2005

(54) Reduced fat and carbohydrate cultured dairy product and process for manufacturing such cultured dairy product

(76) Inventor: Frederic R. Calvert JR., Whitehouse, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/753,767

(22) Filed: Jan. 8, 2004

Related U.S. Application Data
(60) Provisional application No. 60/467,173, filed on May 2, 2003.
(60) Provisional application No. 60/467,174, filed on May 2, 2003.
(60) Provisional application No. 60/448,582, filed on Feb. 21, 2003.
(60) Provisional application No. 60/448,583, filed on Feb. 21, 2003.
(60) Provisional application No. 60/448,581, filed on Feb. 21, 2003.
(60) Provisional application No. 60/516,751, filed on Nov. 4, 2003.
(60) Provisional application No. 60/516,750, filed on Nov. 4, 2003.
(60) Provisional application No. 60/516,749, filed on Nov. 4, 2003.
(60) Provisional application No. 60/516,732, filed on Nov. 4, 2003.
(60) Provisional application No. 60/482,718, filed on Jun. 27, 2003.
(60) Provisional application No. 60/448,584, filed on Feb. 21, 2003.

(51) Int. Cl. A23C 1/00

(52) U.S. Cl. 426/580

(57) ABSTRACT

A reduced fat and carbohydrate, cultured dairy product includes ultra filtered (UF) raw skim milk, water, a fat source, a protein source, and a predetermined amount of live and active cultures (LAC). A process for manufacturing this product includes providing UF skim milk, adding water and a fat source to obtain a first combination; adding a protein source to the first combination to form a second combination; adding a predetermined amount of LAC to the second combination; and placing the second combination, in a container to culture at a temperature of about 40.6° C. for about 4-5 hours or until the pH of the second combination is less than or equal to about 4.65. The first combination may include non-fat milk solids in a range of about 4.5%-6.4% by weight, total solids in a range of about 8.9%-10.5% by weight, and butterfat in a range of 0.44%-2.20% by weight.

### CROSS-REFERENCE TO RELATED APPLICATIONS

This application claims priority from U.S. Provisional Application No. 60/467,173, entitled “REDUCED CARBOHYDRATE, MILK PRODUCT AND PROCESS FOR MANUFACTURING SUCH MILK PRODUCTS” filed May 2, 2003; U.S. Provisional Application No. 60/467,174, entitled “REDUCED FAT AND CARBOHYDRATE, MILK PRODUCT AND PROCESS FOR MANUFACTURING SUCH MILK PRODUCTS,” filed May 2, 2003; U.S. Provisional Application No. 60/448,582, entitled “REDUCED FAT AND CARBOHYDRATE, MILK PRODUCT AND PROCESS FOR MANUFACTURING SUCH MILK PRODUCTS,” filed Feb. 21, 2003; U.S. Provisional Application No. 60/448,583, entitled “REDUCED CARBOHYDRATE, YOGURT PRODUCT AND PROCESS FOR MANUFACTURING SUCH YOGURT PRODUCTS,” filed Feb. 21, 2003; U.S. Provisional Application No. 60/448,581, entitled “REDUCED FAT AND CARBOHYDRATE, YOGURT PRODUCT AND PROCESS FOR MANUFACTURING SUCH YOGURT PRODUCTS,” filed Feb. 21, 2003, all of which are hereby incorporated herein by reference.

### CROSS-REFERENCE TO RELATED APPLICATIONS

This application is related to concurrently filed, co-pending and commonly assigned U.S. patent application Ser. No. ______, Attorney Docket No. 65444-P001US-10316176, entitled “REDUCED CARBOHYDRATE MILK PRODUCT AND PROCESS FOR MANUFACTURING SUCH MILK PRODUCT;” U.S. patent application Ser. No. ______, Attorney Docket No. 65444-P002US-10316179, entitled “REDUCED FAT AND CARBOHYDRATE MILK PRODUCT AND PROCESS FOR MANUFACTURING SUCH MILK PRODUCT;” and U.S. patent application Ser. No. ______, Attorney Docket No. 65444-P003US-10316180, entitled “REDUCED CARBOHYDRATE CULTURED DAIRY PRODUCT AND PROCESS FOR MANUFACTURING SUCH CULTURED DAIRY PRODUCT,” the disclosures of which are hereby incorporated herein by reference.

### TECHNICAL FIELD

The invention relates generally to reduced or low fat and carbohydrate cultured dairy products or yogurt-like products and processes for manufacturing such products. More specifically, the invention relates to reduced or low fat and carbohydrate cultured dairy products, e.g., products which contain fewer carbohydrates and less fat than similar quantities of yogurt or other cultured dairy products of otherwise similar nutritional value, comprising ultra filtered (UF) raw skim milk, water, a fat source, a protein source, and live and active cultures (LACs) and processes for combining these components to manufacture such yogurt products.

### BACKGROUND OF THE INVENTION

Carbohydrates are a primary source of immediate energy for humans. Carbohydrates may be consumed in the form of sugars, starches, or cellulose. During the digestive process, carbohydrates, with the exception of dietary fiber, initially are converted into glucose. The human body may use such glucose in at least three ways. First, glucose may be absorbed directly into the blood stream and delivered to the body's muscles for immediate use. Second, if there is no immediate need for the glucose, it may be stored for later use in the body's muscles in the form of glycogen. Third, if there is no immediate need for the glucose and there is too much glucose or insufficient storage capacity in the body's muscles, the body converts the excess glucose into fat and stores this converted glucose within the body's fat cells. See www.all-healthy.com/content/pod/carbohydrate.aspx.

It is this last use for glucose which helps explain the increased popularity of reduced or low carbohydrate diets. Humans consume three basic sources of energy: fat, carbohydrates, and protein to obtain the calories (energy) necessary to fuel their muscles. Fat provides about nine (9) calories per gram; protein provides about four (4) calories per gram; and carbohydrates also provide about four (4) calories per gram. Id. Diets high in fat, e.g., diets which provide more fat than that which is converted to energy by the consumer or than a daily recommended consumption, or both, have been associated with weight and other health problems in humans. In particular, diets high in fat have been connected with cardiovascular disease. Further, weight problems associated with diets high in fat have been associated with a higher incidence of adult onset or type-11 diabetes. See www.all-healthy.com/content/pod/diabetes.aspx. Consequently, for many years, doctors and dieticians have promoted the benefits of reduced or low fat diets, e.g., diets which provide less fat than that which is converted to energy by the consumer or than a daily recommended consumption, or both. Generally, the goal of these diets is to encourage the conversion of existing stored fat into energy while at the same time reducing the body's intake of new fat.

In recent years, however, the theory behind such reduced or low fat diets has been called into question. Because a gram of fat supplies a proportionally greater percentage of calories to the body, when compared with a gram of protein or carbohydrates, a reduction in one (1) gram of fat consumed has more than twice the impact of a one gram reduction in the consumption of proteins or carbohydrates. Thus, a person consuming a reduced or low fat diet may force his or her body to consume both fat and muscle tissue to make up the body's fuel deficiency. Loss of lean muscle tissue, however, may slow the body's metabolic rate and actually may reduce the body's efficiency in breaking down fat. Alternatively, the dieter may be tempted to increase his or her consumption of proteins or carbohydrates, or both, to replace the calories lost due to the reduced consumption of fat. As noted above, however, persons must consume twice the weight of proteins or carbohydrates, or both, in order to obtain the calories lost through the reduced consumption of fat. If the dieter increases his or her carbohydrate intake to offset the loss of calories caused by the reduced consumption of fat, the body produces an increased supply of glucose. Generally, the body will not breakdown stored fat for fuel when an abundant supply of sugars is available.

Diets combining reduced fat intake, reduced carbohydrate intake, and a moderate intake of protein, e.g., at or about a recommended daily consumption, have been promoted as an alternative to such reduced or low fat diets. As noted above, without sugars from carbohydrates, the human body may be forced to turn to stored fat as a source of energy. If carbohydrate intake is regulated, the body's production of insulin, which facilitates the use of glucose in muscles and the conversion of excess glucose into fat, may be stabilized. Swings in blood sugar levels resulting from unregulated carbohydrate consumption may result in cravings and hunger pangs. When insulin levels are stable, blood sugar levels remain more stable, and the likelihood of cravings and hunger pangs decreases.

Refrigerated yogurt is manufactured by culturing dairy products, such as those permitted by the U.S. Food and Drug Administration, and bacterial cultures. Such bacterial cultures comprise Lactobacillus bulgaricus and Steptococcus thermophilus. These cultures convert pasteurized milk to yogurt during fermentation. In order for yogurt products to carry the seal of the National Yogurt Association (NYA), refrigerated yogurt products must have contained at least 100 million cultures per gram of yogurt at the time of manufacture. See www.aboutyogurt.com/lacYogurt/facts.asp. Because it is manufactured from milk or other dairy products, yogurt provides many of the same nutritional benefits as other milk and dairy products.

Milk and foods containing or consumed with milk, such as yogurt and breakfast cereals, are important sources of fat, carbohydrates, and proteins in many diets. Milk and foods associated with milk also are important sources of essential nutrients, including vitamins, such as Vitamin A and Vitamin D, and minerals, such as calcium. Whole milk contains about 12 gms of carbohydrates per 236.6 cm³ (8 fluid ounce) serving, about 8 gms of carbohydrates per 236.6 cm³ serving, and about 8 gms of fat per 236.6 cm³ serving. Whole milk also provides about 240 mg of calcium or 30% of the U.S. Recommended Daily Allowance (RDA) of calcium per 236.6 cm³ serving. Yogurt may be delivered in about 113 gm (about 4 ounces) servings, which may include component ratios similar to those of whole milk. Thus, whole milk and yogurt may provide one and a half times as many carbohydrates per serving, as fat or protein. Such high carbohydrate content may make milk and yogurts inappropriate in a reduced or low carbohydrate diet.

In reduced or low fat diets, 30% or less of daily calorie intake is derived from fat. Dietary fat may comprise both saturated and unsaturated fatty acids, and saturated fats have been associated with elevated levels of blood cholesterol. Consumption of diets high in saturated fats, especially by persons having elevated blood cholesterol levels, has been associated with obesity and increased risk of cardiovascular disease and of some cancers. Generally, milk and products prepared from milk, such as cheese, are relatively high in fat, and in particular such foods are relatively high in saturated fatty acids. Milk and products made from milk are significant parts of many daily diets, and one way of reducing fat intake is to consume low or reduced fat milk or products made from milk.

In addition, almost all of the carbohydrates in plain yogurt are derived from lactose. Most humans possess lactase, an enzyme that catalyzes the hydrolysis of lactose into glucose and galactose, in their small intestine. However, according to the National Digestive Diseases Information Clearinghouse, between 30 and 50 million Americans lack this enzyme and are unable to digest significant amounts of lactose. Such lactose intolerance may more widely effect certain ethnic and racial populations. By some estimates, 75% of all African Americans and American Indians and 90% of all Asian Americans suffer some degree of lactose intolerance. See www.niddk.nih.gov/health/digest/pubs/lactose/lactose.htm. This intolerance may result in the necessary exclusion of milk, yogurt, and other foods associated with milk entirely from some diets.

### BRIEF SUMMARY OF THE INVENTION

A need has arisen for a cultured dairy product that has reduced fat and low carbohydrate content. It is an advantage of such cultured dairy products that they possess a reduced or low lactose content, e.g., less lactose than in similar quantities of yogurt or other cultured dairy products of otherwise similar nutritional value. It is a feature of such unflavored cultured dairy products that their carbohydrate content is in a range of about 2.21% to about 3.97% by weight. It is yet a further feature of such cultured dairy products that their lactose content is in a range of about 1.33% to about 3.09% by weight. It is still another feature of such cultured dairy products that their fat content is in a range of about 0.44% to about 2.20% by weight.

Another need has arisen for a cultured dairy product that has good organoleptic qualities and good mouthfeel. It is an advantage of the cultured dairy product that avoids the bland taste or a rough or chalky mouthfeel, or both, of some other reconstituted or reduced lactose content, cultured dairy products. It is a feature of the cultured dairy product that its organoleptic qualities and mouthfeel are similar to or substantially the same as those of yogurt made from reduced or low fat milk.

Still another need has arisen for a cultured dairy product that is made from UF skim milk having heat stability during pasteurization and an acceptable shelf life. It is an advantage of the UF skim milk that it may be pasteurized by a Low Temperature Long Time (LTLT) pasteurization process. It is a feature of a UF skim milk pasteurized by LTLT pasteurization processes that it has an extended shelf-life. It is another advantage of the UF skim milk that it may be pasteurized by a High Temperature Short Time (HTST) pasteurization process. It is a feature of a UF skim milk pasteurized by HTST pasteurization processes that it has a shelf-life of up to about eighteen (18) days. It is a further advantage of the UF skim milk that it may be pasteurized by an Ultra High Temperature (UHT) pasteurization process. It is a feature of a UF skim milk pasteurized by UHT pasteurization processes that it has a shelf-life of up to about sixty (60) days. Components of the cultured dairy product, except the LAC, may be heat treated prior to fermentation, e.g., prior to the additon of LAC, to further extend its shelf life.

In an embodiment of the invention, an unflavored, reduced fat and carbohydrate, cultured dairy product is manufactured from ultra filtered (UF) skim milk. This cultured dairy product comprises carbohydrates in a range of about 2.21% to about 3.09% by weight; protein in a range of about 3.98% to about 4.86% by weight; and fat in a range of about 1.33% to about 2.20% by weight.

In another embodiment of the invention, an unflavored, reduced fat and carbohydrate, cultured dairy product is manufactured from UF skim milk. An about 113 gm serving of this cultured dairy product comprises carbohydrates in a range of about 2.50 gms to about 3.49 gms; protein in a range of about 4.50 gms to about 5.49 gms; and fat in a range of about 1.50 gms to about 2.49 gms.

In still another embodiment of the invention, a reduced carbohydrate, cultured dairy product is manufactured from UF skim milk. This cultured dairy product comprises a source of flavoring, such as chocolate flavoring, vanilla flavoring, strawberry flavoring, blueberry flavoring, lemon flavoring, and the like; carbohydrates in a range of about 3.10% to about 3.97% by weight; protein in a range of about 3.98% to about 4.36% by weight; and fat in a range of about 0.44% to about 1.32% by weight.

In yet another embodiment of the invention, a reduced carbohydrate, cultured dairy product is manufactured from UF skim milk. This cultured dairy product comprises a source of flavoring such as vanilla flavoring, strawberry flavoring, blueberry flavoring, lemon flavoring, and the like; and an about 113 gm serving of this cultured dairy product comprises carbohydrates in a range of about 3.50 gms to about 4.49 gms; protein in a range of about 4.50 gms to about 5.49 gms; and fat in a range of about 0.50 gms to about 1.49 gms.

In still another embodiment of the invention, an unflavored, reduced fat carbohydrate, cultured dairy product comprises UF skim milk; water, a fat source, and a protein source and a predetermined amount of LAC. This cultured dairy product further may comprise carbohydrates in a range of about 2.21% to about 3.09% by weight; protein in a range of about 3.98% to about 4.35% by weight; and fat in range of about 1.33% to about 2.20% by weight.

In a further embodiment of the invention, a reduced fat and carbohydrate, cultured dairy product comprise UF skim milk; water, a fat source, and a protein source; a predetermined amount of LAC; and a source of flavoring. This cultured dairy product further may comprise carbohydrates in a range of about 3.10% to about 3.97% by weight; protein in a range of about 3.98% to about 4.86% by weight; and fat in a range of about 0.44% to about 1.32% by weight.

In still a further embodiment of the invention, an unflavored, reduced fat and carbohydrate, cultured dairy product comprises UF skim milk; water, a fat source, and a protein source and a predetermined amount of LAC. The cultured dairy product also comprises lactose in a range of about 1.33% to about 2.30% by weight; fat, (e.g., butterfat) in a range of about 1.33% to about 2.20% by weight; and non-fat milk solids (MSNF) in a range of about 4.5% to about 6.4%.

In yet a further embodiment of the invention, a reduced fat and carbohydrate, cultured dairy product comprises UF skim milk; water, a fat source, and a protein source; a predetermined amount of LAC; and a source of flavoring. The cultured dairy product also comprises lactose in a range of about 2.21% to about 3.09% by weight; fat, e.g., butterfat, in a range of about 0.44% to about 1.32% by weight; and MSNF in a range of about 4.5% to about 6.4%.

In still yet a further embodiment, the invention is a process for manufacturing a cultured dairy product. The process comprises the steps of providing UF skim milk; adding water and a fat source to the UF skim milk to obtain a first combination of UF skim milk, water and a fat source; and adding a protein source to the first combination to form a second combination. The process further comprises the steps of adding a predetermined amount of LAC to the second combination and placing the second combination, including the predetermined amount of LAC, in a tank or other container to ferment at a substantially constant temperature (e.g., about 40.6° C.) for a predetermined period (e.g., for a period of about four (4) hours to about five (5) hours) or until a pH of the second combination is less than or equal to a predetermined pH value (e.g., about 4.65). The first combination may comprise a desired composition of MSNF of about 5.65% by weight, total solids in a range of about 8.9% to about 10.5% by weight, and fat (e.g., butterfat) in range of about 0.44% to about 2.20% by weight. Moreover, the first combination or the second combination may be pasteurized or pasteurized and homogenized prior to the addition of LACs and fermentation.

In still a further embodiment of the invention, a cultured dairy product comprises a first combination comprising UF skim milk, a fat source, and water; a protein source in a range of about 1% to about 2% by weight; and stabilizer. Further, the cultured dairy product comprises a predetermined amount of LAC. The first combination may comprise a desired composition of non-fat, milk solids (MSNF) of about 5.65% by weight, total solids in a range of about 8.9% to about 10.5% by weight, and fat (e.g., butterfat of about 0.44% to about 2.20% by weight.

In yet a further embodiment of the invention, a cultured dairy product comprises a first combination comprising UF skim milk, a fat source, and water, wherein the first combination comprises a desired composition of non-fat, milk solids of about 5.65% by weight, total solids in a range of about 8.9% to about 10.5% by weight, and fat (e.g., butterfat) in a range of about 0.44% to about 2.20% by weight. The first combination also may comprise a protein source, wherein the protein source comprises whey protein concentrate-80 in a range of about 0.5% to about 1% by weight and another protein source, such as calcium caseinate or egg white solids in a range of about 0.5% to about 1% by weight. The combination further may include a predetermined amount of stabilizer. Further, the cultured dairy product comprises a predetermined amount of LAC.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### DETAILED DESCRIPTION OF THE INVENTION

Ultrafiltration of milk employs a membrane separation process. A pressure gradient drives milk through the membrane and the membrane fractionates components of the milk as a function of the component's solvated size and structure. In UF processes, the membrane size is relatively larger allowing larger and more components to pass through the pores with the water. This combined separation and fractionation process uses a 10,000 molecular weight (MW) cutoff, about 276 kPa, and temperatures in a range of about 50° C. to about 60° C. with polysulfone membranes. In UF skim milk, lactose and minerals pass through the membrane in a 50% separation ration. For example, the retentate, i.e., the portion of the milk which does not permeate the filter, may include 100% of the butterfat, 100% of the milk protein, 50% of the lactose, and 50% of the free minerals (including calcium). See www.dairyconsultant.co.uk/pages/Filtration.htm.

The UF skim milk included in the cultured dairy products and used in the processes described herein may comprise lactose in a range of about 4.5% to about 5.5% by weight, butter fat in a range of about 0.4% to about 1.5% by weight, protein in a range of about 9% to about 11.5% by weight, and total solids in a range of about 16% to about 19% by weight. Suitable UF skim milk has a density in a range of about 1.0545 gms/cm³ to about 1.0665 gms/cm³.

In this cultured dairy product, a source of the carbohydrates is lactose. Moreover, substantially all of the carbohydrate composition of the yogurt product may be lactose. Specifically, the lactose may be in a range of about 0.0152 gms/cm³ to about 0.0169 gms/cm³, and more specifically, the lactose may be about 0.0169 gms/cm³. Further, the protein may be in a range of about 0.0338 gms/cm³ to about 0.0507 gms/cm³, and the fat may be less than about 0.0338 gms/cm³. Such suitable UF skim milk is available from Select Milk Products, Inc. of Artesia, N. Mex., USA.

As noted above, in an embodiment of the invention, an unflavored, reduced fat and carbohydrate, cultured dairy product is manufactured from ultra filtered (UF) skim milk. This cultured dairy product comprises carbohydrates in a range of about 2.21% to about 3.09% by weight; protein in a range of about 3.98% to about 4.86% by weight; and fat in a range of about 1.33% to about 2.20% by weight. Preferably, this cultured dairy product comprises carbohydrates in an amount of about 2.65% by weight; protein in an amount of about 4.43% by weight; and fat in an amount of about 1.77% by weight.

As with the embodiment described above, a source of the carbohydrates in this cultured dairy product is lactose. Moreover, substantially all of the carbohydrate composition of the cultured dairy product may be lactose. In a further preferred embodiment, the cultured dairy product may comprise lactose in a range of about 1.33% to about 2.49% by weight and more preferably, in an amount of about 1.77% by weight.

In another embodiment of the invention, an unflavored, reduced fat and carbohydrate, cultured dairy product is manufactured from ultra filtered (UF) skim milk. An about 113 gm serving of this cultured dairy product comprises carbohydrates in a range of about 2.50 gms to about 3.49 gms; protein in a range of about 4.50 gms to about 5.49 gms; and fat in a range of about 1.50 gms to about 2.49 gms. Preferably, this cultured dairy product comprises carbohydrates in an amount of about 3.0 gms; protein in an amount of about 5.0 gms; and fat in an amount of about 2.0 gms. In a further preferred embodiment, the cultured dairy product may comprise lactose in a range of about 1.50 gms to about 2.49 gms and more preferably, in an amount of about 2.0 gms.

In still another embodiment of the invention, a reduced carbohydrate, cultured dairy product is manufactured from UF skim milk. This cultured dairy product comprises a source of flavoring, such as vanilla flavoring, strawberry flavoring, blueberry flavoring, lemon flavoring, and the like; carbohydrates in a range of about 3.10% to about 3.97% by weight; protein in a range of about 3.98% to about 4.86% by weight; and fat in a range of about 0.44% to about 1.32% by weight.

The source of flavoring may be selected from the group consisting of vanilla flavoring, strawberry flavoring, blueberry flavoring, lemon flavoring, and the like. Vanilla flavoring may comprise natural or artificial vanilla powder, vanilla extract, vanilla syrup, or combinations thereof. Strawberry flavoring, blueberry flavoring, or lemon flavoring may comprise natural or artificial strawberry, blueberry, or lemon syrup. Other sources of flavoring also may be used; however, total carbohydrates for cultured dairy products comprising other sources of flavoring preferably remain within the range of about 3.50 gms to about 4.49 gms by weight. In addition, fruit, e.g., up to about 12% by weight of fruit or fruit puree, and a sweetener, e.g., Sucralose, which is available as Splenda® sweetener from McNeil-PPC, Inc. of Milltown, N.J., USA, may be added to the cultured dairy product. Sucralose is preferred because of its clean flavor and its heat stable characteristic.

As with the embodiments described above, a source of the carbohydrates in this cultured dairy product is lactose. Moreover, substantially all of the carbohydrate composition of the cultured dairy product may be lactose. Preferably, this cultured dairy product comprises carbohydrates in an amount of about 3.54% by weight; protein in an amount of about 4.43% by weight; and fat in an amount of about 0.89% by weight. In a further preferred embodiment, the cultured dairy product may comprise lactose in a range of about 2.21% to about 3.09% by weight and more preferably, in an amount of about 2.65% by weight.

In yet another embodiment of the invention, a reduced carbohydrate, cultured dairy product is manufactured from UF skim milk. This cultured dairy product comprises a source of flavoring, such as vanilla flavoring, strawberry flavoring, blueberry flavoring, lemon flavoring, and the like; and an about 113 gm serving of this cultured dairy product comprises carbohydrates in a range of about 3.50 gms to about 4.49 gms; protein in a range of about 4.50 gms to about 5.49 gms; and fat in a range of about 0.50 gms to about 1.49 gms. Preferably, this cultured dairy product comprises carbohydrates in an amount of about 4.0 gms; protein in an amount of about 5.0 gms; and fat in an amount of about 1.0 gm. In a further preferred embodiment, the cultured dairy product may comprise lactose in a range of about 2.50 gms to about 3.49 gms and more preferably, in an amount of about 3.0 gms.

In still yet another embodiment of the invention, an unflavored, reduced fat and carbohydrate, cultured dairy product comprises UF skim milk; water, a fat source, and a protein source, and a predetermined amount of LAC. This cultured dairy product further may comprise carbohydrates in a range of about 2.21% to about 3.09% by weight; protein in a range of about 3.98% to about 4.86% by weight; and fat in a range of about 1.33% to about 2.20% by weight. Preferably, this cultured dairy product comprises carbohydrates in an amount of about 2.65% by weight; protein in an amount of about 4.43% by weight; and fat in an amount of about 1.77% by weight. In a further preferred embodiment, the cultured dairy product may comprise lactose in a range of about 1.33% to about 2.49% by weight and more preferably, in an amount of about 1.77% by weight.

In a further embodiment of the invention, a reduced fat and carbohydrate, cultured dairy product comprises UF skim milk; water, a fat source, and a protein source; a predetermined amount of LAC; and a source of flavoring. This cultured dairy product further may comprise carbohydrates in a range of about 3.10% to about 3.97% by weight; protein in a range of about 3.98% to about 4.86% by weight; and fat in a range of about 0.44% to about 1.32% by weight. Preferably, this cultured dairy product comprises carbohydrates in an amount of about 3.54% by weight; protein in an amount of about 4.43% by weight; and fat in an amount of about 0.89% by weight. In a further preferred embodiment, the cultured dairy product may comprise lactose in a range of about 2.21% to about 3.09% by weight and more preferably, in an amount of about 2.65% by weight.

The fat source may be cream. Forty percent (40%) butterfat cream comprises about 2.78% carbohydrates, about 1.98% protein, and about 40% fat by weight. Substantially all of the carbohydrates in cream are in the form of lactose. Although other sources of fat may be used, cream is preferred for several reasons. Specifically, UF skim milk has a lower calcium content than that of whole milk, and the inclusion of cream in the modified UF skim milk also replaces some of the calcium removed during the ultrafiltration process. Moreover, the addition of cream in the modified UF skim milk improves certain organoleptic characteristics of the cultured dairy product, and in particular, the inclusion of cream contributes to a mouthfeel of the cultured dairy product more closely approaching that of yogurt made from whole milk. If a fat source with a lower fat content than cream is included in the modified UF skim milk, the fat content of the cultured dairy product may be reduced, and a cultured dairy product which has low or reduced fat content, as well as low or reduced carbohydrate content, in comparison to yogurt made from whole milk, may be obtained.

The protein source is preferably neutral in flavor and low in carbohydrate content. Suitable protein sources for inclusion in this embodiment may be selected from the group consisting of egg white solids, whey protein concentrate-80, high (90%) protein whey concentrate, soy protein, milk protein concentrate, calcium caseinate, and combinations thereof. Calcium caseinate may increase total solids in the cultured dairy product and may improve mouthfeel. Preferably, however, the protein source is calcium caseinate or egg white solids or whey protein concentrate-80, or combinations thereof. The whey protein concentrate may be supplied from Davisco Foods International Inc., Eden Prairie, Minn. These sources do not have a significant negative impact on the flavor of the cultured dairy product, and each alone and both in combination have low or reduced carbohydrate content relative to the other protein sources. Moreover, the addition of calcium caseinate or whey protein concentrate-80, or a combination thereof in the cultured dairy product improves certain organoleptic characteristics of the cultured dairy product, and in particular, the inclusion of calcium caseinate or whey protein concentrate-80, or a combination thereof contributes to a mouthfeel of the cultured dairy product more closely approaching that of yogurt made from whole milk.

As with the embodiments described above, this cultured dairy product also may comprise a stabilizer, a sweetener, a preservative, or combinations thereof. The considerations described above with respect to the selection and inclusion of these additional cultured dairy product components apply to this embodiment as well. Moreover, regardless of the addition of preservatives, the modified UF skim milk preferably is pasteurized. Once again, the modified UF skim milk may be pasteurized by one of the pasteurization processes described above. Further, as noted above, if the modified UF skim milk is pasteurized by an UHT or an HTST pasteurization process, it may not be necessary to add preservatives to the cultured dairy product. HTST pasteurization process, it may not be necessary to add preservatives to the cultured dairy product.

UHT pasteurization processes may be accomplished by one of two methods: (1) direct heating and (2) indirect heating. In direct heating methods, the modified UF skim milk comes into direct contact with potable, culinary quality steam. An advantage of this UHT method is that the milk product's temperature may be quickly elevated and, thus, the modified UF skim milk product may be maintained at the pasteurization temperature for a shorter period of time. When pasteurizing a heat sensitive product, such as milk or milk products, the shorter period during which the milk product's temperature is elevated the lower the likelihood that heat damage will occur. Pasteurization and sterilization of milk and milk products are discussed in detail in Chapters 5 and 6 of Michael Lewis and Niel Heppell, Continuous Thermal Processing of Foods, Pasteurization and UHT Sterilization (Aspen Publishers, Inc. 2000), which is incorporated herein by reference.

Direct heating itself may be accomplished by one of at least two methods: (1) injection heating and (2) infusion heating. In injection heating, the modified UF skim milk is pre-heated, and the steam then is injected directly into the pre-heated, modified UF skim milk. By pre-heating the modified UF skim milk, scalding may be reduced or avoided. Steam injection causes the milk temperature to rise rapidly, and after a predetermined holding period, the modified UF skim milk is flash cooled in a vacuum to remove an amount of water equivalent to that added by the condensing steam. Injection heating may have cost disadvantages because significant amounts of energy are expended in producing the steam and cooling the modified UF skim milk. Further, because of the high temperatures involved and the direct contact between the modified UF skim milk and the steam and steam heated equipment, the flavor of the cultured dairy product may be adversely affected.

In infusion heating, the modified UF skim milk is pumped into a chamber filled with high pressure steam, in which the modified UF skim milk may form a free falling film. The chamber is sized and the flow of modified UF skim milk is controlled, such that the fall time corresponds to a predetermined holding time. Because the bottom of the chamber is relatively cool, the heated modified UF skim milk film falls onto and collects on a relatively cool surface, from which the modified UF skim milk may be removed for flash cooling in a vacuum to remove an amount of water equivalent to that added by the condensing steam. Infusion heating has several advantages over injection heating, including rapid heating and rapid cooling of the modified UF skim milk, more uniform heating and the elimination or reduction of hot spots, and greater suitability for lower and higher viscosity products.

Indirect heating may be accomplished using a variety of heat exchanger systems, such as Plate Heat Exchanger Systems, Tubular Heat Exchanger Systems, Scraped Surface Heat Exchangers, and Double-Cone Heat Exchangers. Plate and Tubular Heat Exchanger Systems generally are more suitable for milk or milk products. In a Plate Heat Exchanger System, the modified UF skim milk may be applied to a heated plate in order to heat the modified UF skim milk. A pattern may be formed on the plate in order to increase the turbulence of the modified UF skim milk contacting the plate surface. Because milk and milk products are heat labile substances, sterilization of modified UF skim milk in Plate Heat Exchanger Systems may result in the eventual fouling of the plate surface. Although more frequent cleaning may be required, such systems allow for improved temperature control, are of relatively simple configuration, and allow for relatively high throughput. Tubular Heat Exchanger Systems may occur in various configurations, including tube in shell, coil in shell, double tube, and triple tube. A common feature of each of these configurations is that either the heating medium or the milk product may flow in a tube, a coil, or a tube within a tube, so that it may supply heat to a modified UF skim milk while remaining physically isolated from the modified UF skim milk or so that it may receive heat from a heating medium while remaining physically isolated from the heating medium. Scraped Surface Heat Exchangers and Double-Cone Heat Exchangers generally are used for more viscous products and for products containing particulates.

In still a further embodiment of the invention, an unflavored, reduced fat and carbohydrate, cultured dairy product comprises UF skim milk; water, a fat source, and a protein source, and a predetermined amount of LAC. The cultured dairy product also comprises lactose in a range of about 1.33% to about 2.20% by weight; fat, e.g., butterfat in a range of about 1.33% to about 2.20% by weight; and MSNF in a range of about 4.5% to about 6.4%. Preferably, this cultured dairy product comprises lactose in an amount of about 1.77% by weight and fat in an amount of about 1.77% by weight.

Whole milk provides about 30% of the U.S. Recommended Daily Allowance of calcium (i.e., 800 mgs) for adult men and women. The cultured dairy product of the present invention may provide calcium in the range of about 0.10% to about 0.12% by weight and, preferably, in an amount of equal to or greater than about 0.11% by weight. Consequently, an about 113 gm serving of a cultured dairy product according tot his invention comprises calcium in a range of about 110 mgs to about 130 mgs and, preferably, an amount equal to or greater than about 120 mgs.

The cultured dairy product further may comprise a stabilizer. Stabilizers may be added to control sedimentation and to improve the overall appearance and viscosity of the cultured dairy product. Stabilizers that may be used alone or in combination include an edible hydrophilic colloids (i.e., starches, including pregelatinized starches and chemically modified starches), a natural or synthetic gum, or a chemically modified polysaccharide. Suitable stabilizers include acacia, agar, algin, carrageenan, Polysorbate 80, lecithin, tapioca, gelatin, gum arabic, gum ghatti, gum karaya, gum tragacanth, guar gum, locust bean gum, xanthan gum, sodium alginate, and cellulose gums (e.g., methyl cellulose, hydroxy ethyl cellulose, hydroxypropyl cellulose, hydoxypropyl methylcellulose, and carboxymethylcellulose, and combinations thereof). In a further preferred embodiment, the stabilizer is selected from the group consisting of carrageenan, polysorbate 80, tapioca, gelatin, modified food starch, lecithin, and combinations thereof. Gelatin is most preferred, however, because it is an effective stabilizer in small amounts by weight. This allows the manufacturer to add fewer carbohydrates to the finished product. Another stabilizer is CC-323 calcium fortified ice cream stabilizer, which is available form Continental Custom Ingredients, Inc. of West Chicago, Ill.; and comprises tricalcium phosphate and calcium lactate, which is standardized with dextrose. Whatever stabilizer is selected, preferably, it may be used in small amounts by weight. If a starch is used, preferably, it may be used in effective amounts which will not significantly affect the carbohydrate content of the yogurt product.

Because the lactose content of the UF skim milk, and consequently, the lactose content of the cultured dairy product, is reduced in comparison to that of yogurt made from whole milk, it may be desirable to add a sweetener to the cultured dairy product to improve its organoleptic properties. In particular, in a preferred embodiment, the cultured dairy product has organoleptic properties similar to or substantially the same as those of yogurt made from whole milk. It is further preferred that the sweetener add no or no significant additional carbohydrate content to the cultured dairy product; that the sweetener is heat stable and able to withstand pasteurization and heat treatment temperatures or cooking temperatures, or both, without significant degradation or breakdown; and that the sweetener possess a clean flavor and not exhibit significant bitter or other aftertastes. Sucralose, which is available as Splenda® sweetener from McNeil-PPC, Inc. of Milltown, N.J., USA, is a suitable sweetener. Sucralose is preferred because of its clean flavor and its heat stable characteristic. Acesulfame-potassium also may be a suitable sweetener when used in combination with another sweetener which masks the somewhat bitter aftertaste of the acesulfame-potassium.

The cultured dairy product further may comprise a preservative to extend the shelf-life of the cultured dairy product. Preferred preservatives add no or no significant off flavors to the cultured dairy product. Suitable preservatives may be selected from the group consisting of potassium sorbate, sodium benzoate, and combinations thereof. Nevertheless, potassium sorbate is preferred over sodium benzoate because potassium sorbate adds less off flavor to the cultured dairy product.

Regardless of the addition of preservatives, the cultured dairy product is preferably pasteurized. The shelf life of whole milk varies with pasteurization process. For example, if an HTST pasteurization process is used, whole milk may have a commercial shelf-life of about 14-18 days. If, however, UHT pasteurization process is used, whole milk may have a commercial shelf-life of about 50-60 days. Given the use of the same pasteurization process, the modified UF skim milk used to make the cultured dairy product may achieve a similar or substantially the same shelf-life as that of whole milk. Components of the cultured dairy product, except for LAC, may be heat treated prior to fermentation, e.g., prior to the addition of LAC, to further extend the cultured dairy product's shelf life. For example, after such heat treatment, a combination comprising UF skim milk, water, a fat source, and a protein source may be placed in a vat and heated to a temperature in a range of about 82.2° C. to about 93.3° C. and held at that temperature for a period of up to about 30 minutes. This post-pasteurization heating kills bacteria that may remain after pasteurization and improves the organoleptic properties of the cultured dairy product. After the heated components have been allowed to cool, LAC are added as described herein.

The modified UF skim milk may be pasteurized by at least three (3) known pasteurization processes. In an LTLT pasteurization process, the modified UF skim milk may be heated to a temperature of at least about 62.7° C. and to maintain that temperature for not less than thirty (30) minutes. An LTLT pasteurization system may comprise a vat, e.g., an open vat, in which a quantity of modified UF skim milk is temperature for at least about 30 minutes. The modified UF skim milk then is rapidly chilled to less than about 5° C., and preferably, to less than about 4.44° C.

Alternatively, the modified UF skim milk may be placed in sealed containers, LTLT pasteurized in shallow vats, and then cooled by a cool, flowing-water bath. In an example of an HTST pasteurization process, the modified UF skim milk is heated to a temperature of not less than about 72° C. and maintained at that temperature for not less than between about fifteen (15) and sixteen (16) seconds. The modified UF skim milk then is rapidly chilled to less than about 5° C., and preferably, to less than about 4.44° C.

An HTST pasteurization system may comprise a plate-frame heat exchanger, a holding tube, a flow diversion valve for removing milk product from the system, and a time-temperature recording means. Such systems are designed to perform continuous pasteurization operations. A milk product passing though an HTST pasteurization is preheated in a heat recovery portion of the system. The “hold tube” is the tubing in the system that transports the milk product after the point at which the milk product is preheated to about 72° C. The tubing is sized, such that passage of the milk product through the system takes between about 15 and about 20 seconds. When the milk product reaches the end of the hold tube, if the temperature is at about 72° C. (or hotter), the milk product is deemed pasteurized. The temperature of the milk product then is lowered in a heat recovery portion of the system. The milk product then may be cooled and transferred to storage. HTST systems also may comprise such additional equipment as a vacuum chamber to remove volatile off flavors form the pasteurized milk product, and a homogenizer. In an example of a UHT pasteurization process, the modified UF skim milk is heated to at least about 141° C. to about 142° C. for a period of about two (2) to three (3) seconds. Once again, the modified UF skim milk then is rapidly chilled to less than about 5° C., and preferably, to less than about 4.44° C. If the modified UF skim milk is pasteurized by an UHT the cultured dairy product also comprises lactose in a range of about 2.21% to about 3.09% by weight; fat, e.g., butterfat, in a range of about 0.44% to about 1.32% by weight; and MSNF in a range of about 4.5% to about 6.4%.

In yet a further embodiment of the invention, a reduced fat and carbohydrate, cultured dairy product comprises UF skim milk, water, a fat source, and a protein source; a predetermined amount of LAC; and a source of flavoring. The cultured dairy product also comprises lactose in a range of about 2.21% to about 3.09% by weight; fat (e.g., butterfat) in a range of about 0.44% to about 1.32% by weight; and non-fat milk solids in a range of about 4.5% to about 6.4%. Preferably, this cultured dairy product comprises lactose in an amount of about 2.65% by weight and fat in any amount of about 0.89% by weight. The source of flavoring in this embodiment further may comprise any of those described above.

In still yet another embodiment, the cultured dairy product comprises a first combination comprising UF skim milk, a fat source, and water; a protein source in a range of about 1% to about 2% by weight; and a stabilizer. The cultured dairy product further comprises a predetermined amount of LAC. In this cultured dairy product, the first combination may comprise a desired composition of non-fat milk solids of about 5.65% by weight, total solids in a range of about 8.9% to about 10.5% by weight, and fat (e.g., butterfat) in range of about 0.44% to about 2.20% by weight. Preferably, in an unflavored, cultured dairy product, the product comprises fat in a range of about 1.33% to about 2.20% by weight, and more preferably, in amount of about 1.77% by weight. In a flavored, cultured dairy product, however, the product preferable comprises fat in a range of about 0.44% to about 1.32% by weight, and more preferably, in an amount of about 0.89% by weight.

The protein source for this embodiment preferably comprises whey protein concentrate-80 in a range of about 0.5% to about 1% by weight and calcium caseinate or egg white solids or other protein source in a range of about 0.5% to about 1% by weight. Further, the fat source again may be cream. As noted above, the selection of either of these components for the respective protein and fat source in this embodiment of the cultured dairy product contributes to improved organoleptic characteristics of the cultured dairy product. In particular, each component, alone or in combination, contributes to a mouthfeel of the cultured dairy product more closely approaching that of yogurt made from whole milk.

As with the embodiments described above, this cultured dairy product also may comprise a stabilizer, a sweetener, a preservative, or combinations thereof. In particular, the cultured dairy product may comprise gelatin as a stabilizer, Sucralose as a sweetener, and a preservative selected from the group consisting of potassium sorbate, sodium benzoate, and combinations thereof. The considerations described above with respect to the selection and inclusion of these additional cultured dairy product components apply to this embodiment as well. Moreover, regardless of the addition of preservatives, the modified UF skim milk preferably is pasteurized. Once again, the modified UF skim milk may be pasteurized by any of the pasteurization processes described above. Further, as noted above, if the modified UF skim milk is pasteurized by an UHT or a HTST pasteurization process, it may be unnecessary to add preservatives to the cultured dairy product.

A further embodiment, a cultured dairy product comprises a first combination comprising UF skim milk, a fat source, and water; a protein source; potassium sorbate as a preservative, a predetermined amount of Sucralose, and a predetermined amount of gelatin. The cultured dairy product further comprises a predetermined amount of LAC. The first combination comprises a desired composition of non-fat milk solids of about 5.65% by weight, total solids in a range of about 8.9% to about 10.5% by weight, and fat (e.g, butterfat) in a range of about 0.44% to about 2.20% by weight. Further, the protein source comprises whey protein concentrate-80 in a range of about 0.5% to about 1% by weight and calcium caseinate or egg white solids in a range of about 0.5% to about 1% by weight. Preferably, in an unflavored, cultured dairy product, the product comprises fat in a range of about 1.33% to about 2.20% by weight, and more preferably, in an amount of about 1.77% by weight. In a flavored, cultured dairy product, however, the product preferably comprises fat in a range of about 0.44% to about 1.32% by weight, and more preferably, in an amount of about 0.89% by weight.

In still yet a further embodiment, the invention is a process for manufacturing a cultured dairy product, such as those described above, and cultured dairy products manufactured by such processes. The process may comprise the steps of providing UF skim milk; adding water and a fat source to the UF skim milk to obtain a first combination of UF skim milk, water and a fat source; and adding a source of protein to the first combination to form a second combination. In this process, the first combination may comprise a desired composition of non-fat, milk solids of about 5.65% by weight, total solids in a range of about 8.9% to about 10.5% by weight, and butterfat in a range of about 0.44% to about 2.20% by weight. The process further may comprise the steps of determining a first content of non-fat, milk solids by weight, a second content of total solids by weight, and a third content of butterfat by weight of the ultra filtered milk and determining a first amount of water and a second amount of a fat source to add to the UF skim milk to obtain the desired composition of the first combination. This process further comprises the step of adding a predetermined amount of LAC and placing the second combination including the predetermined amount of LAC, e.g., 0.1268 gms/L or an amount, such that the cultured dairy product comprises at least 100 million cultures per gram of cultured dairy product at the time of manufacture, in a tank or other container to ferment at a substantially constant temperature, e.g., about 40.6° C., until the pH of this mixture is less than or equal to a predetermined pH value, e.g., less than or equal to about 4.65, due to the production of lactic acid during fermentation.

As noted above, the cultured dairy product may comprise a sweetener added to improve the cultured dairy products organoleptic properties. Thus, the process further may comprise the step of adding a predetermined amount of a sweetener to the first combination to form a second combination.

Moreover, the process further may comprise the step of determining the content of the second combination, homogenizing the second combination, pasteurizing the second combination, or combinations thereof. Homogenization is a process by which the size of the fat globules suspended in a dairy product may be decrease and the number of fat globules in the dairy product may be increased, such that the tendency of the fat globules to cream is reduced and the fat globules remain dispersed throughout the dairy product. During homogenization, the dairy product may be forced throughout tiny holes or gaps, such as a relatively small gap created between a valve and a valve seat. The homogenization process may involve passing the dairy product thought a series of such holes or gaps. The homogenization process may operate as a result of the turbulence and cavitation created by the passage of the dairy product through such holes and gaps. Homogenization allows dairy products to obtain and retain a smooth and creamy texture over time. If the process comprises the step of pasteurizing the second combination, the pasteurization process may be an LTLT pasteurization process, an HTST pasteurization process, or a UHT pasteurization process.

The invention is further clarified by a consideration of the following examples, which are intended to be purely exemplary of the product or processes, or both, of the invention.

### EXAMPLES

### Example 1

The amounts of UF skim milk, cream (40% butterfat), and water used to formulate the unflavored cultured dairy product initially may vary between batches because test results for non-fat, milk solids, butterfat, and total solids for UF skim milk and cream may vary. Nevertheless, each batch may be standardized to the following content values: non-fat, milk solids of about 5.65% (excluding whey protein concentrate-80), fat in a range of about 1.33% to about 2.20%, and total solids in a range of about 8.9% to about 10.5%, by weight. Suitable UF skim milk is available from Select Milk Products, Inc. of Artesia, N. Mex., USA. In UF skim milk, lactose and minerals pass through the membrane in a 50% separation ratio. For example, the retentate, i.e., the portion of the milk which does not permeate the filter, may include 100% of the butterfat, 100% of the milk protein, 50% of the lactose, and 50% of the free minerals (including calcium). The UF skim milk included in this cultured dairy product and used in the processes described herein may comprise lactose in a range of about 4.5% to about 5.5% by weight, butter fat in a range of about 0.4% to about 1.5% by weight, protein in a range of about 9% to about 11.5% by weight, and total solids in a range of about 16% to about 19% by weight. Suitable UF skim milk has a density in a range of about 1.0545 gms/cm3 to about 1.0665 gms/cm3.

Consequently, an example of a 3,785.41 liter (1,000 gallon) batch of HTST pasteurized, unflavored, cultured dairy product is as follows:

| | |
|---|---|
| Component | Kilograms |

| | | |
|---|---|---|
| UF skim milk | 1,270.91 | kg |
| Cream | 181.15 | kg |
| Water | 2,270.19 | kg |
| Davisco ® Whey Protein Concentrate-80 | 31.99 | kg |
| Calcium Caseinate | 31.99 | kg |
| CC-323 Calcium Fortifier | 5.09 | kg |
| Salt | 5.92 | kg |
| Danisco ® #5961 Stabilizer | 87.34 | kg |

Salt may be sodium chloride or a reduced sodium, salt substitute, or combinations thereof. Danisco® #5961 Stabilizer is available form Danisco Cultor USA, Inc., New Century, Kans. After mixing, the liquid combination described above is subjected to HTST pasteurization, such as by the HTST system or processes described above, and homogenization. Egg white solids have been omitted from this formulation and partially replaced with calcium caseinate in order to simplify the batching process. Further, egg whites are a known food allergen, and the use of egg white solids in the batching process necessitates the thorough cleaning of the hatching and pasteurization equipment between batches. Live and active cultures, such as F-DVS YO FAST-20 Culture, are added to the combination, in an amount of about 0.1268 gms/L or about 0.50 kgs/3,785.41 L batch, or an amount, such that the cultured dairy product comprises at least about 100 million cultures per gram of cultured dairy product at the time of manufacture, then is added to the foregoing mixture. As noted above, fruit, e.g., up to about 12% by weight of fruit or fruit puree, and a sweetener, e.g., Sucralose, which is available as Splenda® sweetener, may be added to the cultured dairy product.

### Example 2

The amounts of UF skim milk, cream (40% butterfat), and water used to formulate the unflavored, cultured dairy product initially may vary between batches because test results for MSNF, butterfat, and total solids for UF skim milk and cream may vary. Nevertheless, each batch may be standardized to the following content values: MSNF of about 5.65% (excluding whey protein concentrate-80), fat in a range of about 3.5% to about 4%, and total solids in a range of about 10.25% to about 11.5%, by weight.

Suitable UF skim milk is available from Select Milk Products, Inc. of Artesia, N. Mex., USA. In UF skim milk, lactose and minerals pass through the membrane in a 50% separation ratio. For example, the retentate, i.e., the portion of the milk which does not permeate the filter, may include 100% of the butterfat, 100% of the milk protein, 50% of the lactose, and 50% of the free minerals (including calcium). The UF skim milk included in this cultured dairy products and used in the processes described herein may comprise lactose in a range of about 4.5% to about 5.5% by weight, butter fat in a range of about 0.4% to about 1.5% by weight, protein in a range of about 9% to about 11.5% by weight, and total solids in a range of about 16% to about 19% by weight. Suitable UF skim milk has a density in a range of about 1.0545 gms/cm3 to about 1.0665 gms/cm3.

Consequently, an example of a 3,785.41 liter (1,000 gallon) batch of an HTST pasteurized, unflavored, cultured dairy product is as follows:

| Component | Kilograms | |
|---|---|---|
| UF Skim Milk | 1270.91 | kg |
| Cream | 181.15 | kg |
| Water | 2270.19 | kg |
| Davisco ® Whey Protein Concentrate-80 | 31.99 | kg |
| Calcium Caseinate | 31.99 | kg |
| CC-323 Calcium Fortifier | 5.09 | kg |
| Salt | 5.92 | kg |
| Danisco ® #5961 Stabilizer | 87.34 | kg |

Salt may be sodium chloride or a reduced sodium, salt substitute, or combinations thereof. Danisco® #5961 Stabilizer is available from Danisco Cultor USA, Inc., New Century, Kans. After mixing, the liquid combination described above is subjected to UHT pasteurization, such as by the UHT systems or processes described above, and homogenization. Egg white solids have been omitted from this formulation and partially replaced with calcium caseinate in order to simplify the batching process. Further, egg whites are a known food allergen, and the use of egg white solids in the batching process necessitates the thorough cleaning of the batching and pasteurization equipment between batches. Live and active cultures, such as F-DVS YO FAST-20 Culture, are added to the combination, in an amount of about 0.1319 gms/L or about 0.5 kgs/3,785.41 L batch, or an amount, such that the cultured dairy product comprises at least about 100 million cultures per gram of cultured dairy product at the time of manufacture, then is added to the foregoing mixture. As noted above, fruit, e.g, up to about 12% by weight of fruit or fruit puree, and a sweetener, e.g., Sucralose, which is available as Splenda® sweetener, may be added to the cultured dairy product.

### Example 3

With respect to the processes described above, the components of the cultured dairy product may be mixed in the following order. First, the manufacturer may place a measured amount of UF skim milk into a mix vat. Load cells or liquid metering devices, or both, may be used to ensure accuracy. Second, the manufacturer may meter into the vat the desired amounts of water and cream. Third, the manufacturer then may add pre-weighed powdered (i.e., dry ingredients) through a mixer/blender or a powder horn. While adding these components, the manufacturer endeavors to keep foaming to minimum. Fourth, the manufacturer may add a premeasured quantity of liquid Sucralose. Fifth, the manufacturer tests the modified UF skim milk composition of carbohydrates, lactose, butterfat, protein, MSNF, and total solids, prior to pasteurization and homogenization. Sixth, the modified UF skim milk composition described above is subjected to HTST pasteurization, such as by the HTST processes described above, and to homogenization. Seventh, the manufacturer adds a predetermined amount of LAC, e.g., 0.1268 gms/L or an amount, such that the cultured dairy product comprises at least 100 million cultures per gram of cultured dairy product at the time of manufacture, to the foregoing mixture. Eighth, the mixture including the predetermined amount of LAC is placed in a tank or other container to ferment at a temperature of about 40.6° C. for a period of about four (4) hours to about five (5) hours or until the pH of the mixture is less than or equal to about 4.65 due to the production of lactic acid during fermentation. Ninth, the manufacturer may add an additional amount of sweetener or natural or artificial flavorings, or both.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A reduced fat and carbohydrate, cultured dairy product, which is manufactured from ultra filtered skim milk, comprising:
carbohydrates in a range of about 2.21% to about 3.09% by weight;
protein in a range of about 3.98% to about 4.86% by weight;
fat in a range of about 1.33% to about 2.20% by weight;
and a predetermined amount of live and active cultures.

2. The cultured dairy product of claim 1, wherein a source of said carbohydrates is lactose.

3. The cultured dairy product of claim 2, wherein said lactose is in a range of about 1.33% to about 2.20% by weight.

4. The cultured dairy product of claim 1, wherein said protein is in an amount of about 4.43% by weight.

5. The cultured dairy product of claim 3 wherein said lactose is in an amount of about 1.77% by weight.

6. The cultured dairy product of claim 1, wherein said fat is in an amount of about 1.77% by weight.

7. The cultured dairy product of claim 1, further comprising calcium in a range of about 0.10% to about 0.12% by weight.

8. The cultured dairy product of claim 7, wherein said calcium is in an amount of about 0.11% by weight.

9. The cultured dairy product of claim 1, further comprising a stabilizer.

10. The cultured dairy product of claim 8, wherein said stabilizer is selected from the group consisting of gelatin, carrageenan, polysorbate 80, tapioca, modified food starch, lecithin, and combinations thereof.

11. The cultured dairy product of claim 1, further comprising Sucralose.

12. The cultured dairy product of claim 1, further comprising a preservative.

13. A reduced fat and carbohydrate, cultured dairy product, which is manufactured from ultra filtered skim milk, comprising:
a source of flavoring;
carbohydrates in a range of about 3.10% to about 3.97% by weight;
protein in a range of about 3.98% to about 4.86% by weight;
fat in a range of about 0.44% to about 1.32% by weight; and
a predetermined amount of live and active cultures.

14. The cultured dairy product of claim 13, wherein a source of said carbohydrates is lactose.

15. The cultured dairy product of claim 14, wherein said lactose is in a range of about 2.21 to about 3.09% by weight.

16. The cultured dairy product of claim 13, wherein said protein is in an amount of about 4.43% by weight.

17. The cultured dairy product of claim 15 wherein said lactose is in an amount of about 2.65% by weight.

18. The cultured dairy product of claim 13, wherein said fat is in an amount of about 0.89% by weight.

19. The cultured dairy product of claim 13, further comprising calcium in a range of about 0.10% to about 0.12% by weight.

20. The cultured dairy product of claim 19, wherein said calcium is in an amount of about 0.11% by weight.

21. The cultured dairy product of claim 13, wherein said source of flavoring is selected from the group consisting of vanilla flavoring, strawberry flavoring, blueberry flavoring, and lemon flavoring.

22. A reduced fat and carbohydrate, cultured dairy product comprising: ultra filtered skim milk, water, a fat source, a protein source, and a predetermined amount of live and active cultures.

23. The cultured dairy product of claim 22, wherein said fat source is cream.

24. The cultured dairy product of claim 22, wherein said protein source is selected from the group consisting of egg white solids, whey protein concentrate-80, milk protein concentrate, soy protein, calcium caseinate, and combinations thereof.

25. The cultured dairy product of claim 22, further comprising a stabilizer.

26. The cultured dairy product of claim 22, wherein said stabilizer is selected from the group consisting of gelatin, carrageenan, polysorbate 80, tapioca, modified food starch, lecithin, and combinations thereof.

27. The cultured dairy product of claim 22, further comprising Sucralose.

28. The cultured dairy product of claim 22, further comprising a preservative.

29. The cultured dairy product of claim 22, wherein said preservative is selected from the group consisting of potassium sorbate, sodium benzoate, and combinations thereof.

30. The cultured dairy product of claim 22, wherein said cultured dairy product further comprises:
carbohydrates in a range of about 2.21% to about 3.09% by weight;
protein in a range of about 3.98% to about 4.86% by weight; and
fat in a range of about 1.33% to about 2.20% by weight.

31. The cultured dairy product of claim 22, wherein said cultured dairy product further comprises:
a source of flavoring;
carbohydrates in a range of about 3.10% to about 3.97% by weight;
protein in a range of about 3.98% to about 4.86% by weight; and
fat in a range of about 0.44% to about 1.32% by weight.

32. A reduced fat and carbohydrate, cultured dairy product, which is manufactured from ultra filtered skim milk, comprising:
carbohydrates in a range of about 2.50 gms to about 3.49 gms per serving;
protein in a range of about 4.50 gms to about 5.49 gms per serving;
fat in a range of about 1.50 gms to about 2.49 gms per serving; and
a predetermined amount of live and active cultures,
wherein said serving is about 113 gms of said cultured dairy product.

33. The cultured dairy product of claim 32, wherein a source of said carbohydrates is lactose.

34. The cultured dairy product of claim 33, wherein said lactose is in a range of about 1.50 gms to about 2.49 gms per serving.

35. The cultured dairy product of claim 32, wherein said protein is in an amount of about 5.0 gms per serving.

36. The cultured dairy product of claim 33 wherein said lactose is in an amount of about 2.0 gms per serving.

37. The cultured dairy product of claim 32, wherein said fat is in an amount of about 2.0 gms per serving.

38. A reduced fat and carbohydrate, cultured dairy product, which is manufactured from ultra filtered skim milk, comprising:
a source of flavoring;
carbohydrates in a range of about 3.50 gms to about 4.49 gms per serving;
protein in a range of about 4.50 gms to about 5.49 gms per serving;
fat in a range of about 0.50 gms to about 1.49 gms per serving; and
a predetermined amount of live and active cultures,
wherein said serving is about 113 gms of said cultured dairy product.

39. The cultured dairy product of claim 38, wherein a source of said carbohydrates is lactose.

40. The cultured dairy product of claim 39, wherein said lactose is in a range of about 2.50 gms to about 3.49 gms per serving.

41. The cultured dairy product of claim 38, wherein said protein is in an amount of about 5.0 gms per serving.

42. The cultured dairy product of claim 39 wherein said lactose is in an amount of about 3.0 gms per serving.

43. The cultured dairy product of claim 38, wherein said fat is in an amount of about 1.0 gms per serving.

44. A reduced fat and carbohydrate, cultured dairy product comprising: ultra filtered skim milk, water, a fat source, a protein source, and a predetermined amount of live and active cultures and further comprising lactose in a range of about 1.33% to about 2.20% by weight; fat in a range of about 1.33% to about 2.20% by weight; and non-fat milk solids in a range of about 4.5% to about 6.4%.

45. A reduced fat and carbohydrate, cultured dairy product comprising: ultra filtered skim milk, water, a fat source, a protein source, a source of flavoring, and a predetermined amount of live and active cultures and further comprising lactose in a range of about 2.21% to about 3.09% by weight; fat in a range of about 0.44% to about 1.32% by weight; and non-fat milk solids in a range of about 4.5% to about 6.4%.

46. The cultured dairy product of claim 45, wherein said source of flavoring is selected from the group consisting of chocolate flavoring, vanilla flavoring, strawberry flavoring, blueberry flavoring, and lemon flavoring.

47. A process for manufacturing a reduced fat and carbohydrate, cultured dairy product, comprising the steps of:
providing ultra filtered skim milk;
adding water and a fat source to said ultra filtered skim milk to obtain a first combination of ultra filtered milk, water, and a fat source, wherein said fat source provides fat in a range of about 0.44% to about 2.20% by weight of said cultured dairy product;
adding a protein source to said first combination to form a second combination; and
adding a predetermined amount of live and active cultures to said second combination.

48. The process of claim 47, wherein said first combination comprises a desired composition of non-fat milk solids of about 5.65% by weight and total solids in a range of about 8.9% to about 10.5% by weight.

49. The process of claim 47, further comprising the steps of:
determining a first content of non-fat milk solids by weight, a second content of total solids by weight, and a third content of butter fat by weight of said ultra filtered milk; and
determining a first amount of water and a second amount of a fat source to add to said ultra filtered milk to obtain said desired composition of said first combination.

50. The process of claim 47, further comprising the step of adding a predetermined amount of a sweetener to said first combination to form a second combination.

51. The process of claim 50, further comprising the step of determining the content of said second combination.

52. The process of claim 50, further comprising the step of homogenizing said second combination.

53. The process of claim 50, further comprising the step of pasteurizing said second combination.

54. The process of claim 50, wherein said pasteurization step further comprises pasteurizing said second combination by a HTST pasteurization process.

55. The process of claim 47, further comprising the step of heat treating said cultured dairy product.

56. The process of claim 47, further comprising the step of placing said second combination including said predetermined amount of LAC into a container to ferment at a temperature of about 40.6° C. until a pH of said second combination is less than or equal to about 4.65.

57. A reduced fat and carbohydrate, cultured dairy product manufactured by the process of claim 47.

58. The cultured dairy product of claim 57, further comprising:
carbohydrates in a range of about 2.21% to about 3.09% by weight;
protein in a range of about 3.98% to about 4.86% by weight;
fat in a range of about 1.33% to about 2.20% by weight.

59. A reduced fat and carbohydrate, cultured dairy product comprising:
a first combination comprising ultra filtered skim milk, a fat source, and water, wherein said fat source provides fat in a range of about 0.44% to about 2.20% by weight;
a protein source in a range of about 1% to about 2% by weight; a stabilizer; and
a predetermined amount of live and active cultures.

60. The cultured dairy product of claim 59, wherein said first combination comprises a desired composition of non-fat milk solids of about 5.65% by weight and total solids in a range of about 8.9% to about 10.5% by weight.

61. The cultured dairy product of claim 59, wherein said protein source comprises whey protein concentrate-80 in a range of about 0.5% to about 1% by weight and calcium caseinate in a range of about 0.5% to about 1% by weight.

62. The cultured dairy product of claim 59, wherein said fat source is cream.

63. The cultured dairy product of claim 59, wherein said stabilizer is selected from the group consisting of gelatin, carrageenan, polysorbate 80, tapioca, modified food starch, lecithin, and combinations thereof.

64. A reduced fat and carbohydrate, cultured dairy product comprising:
a first combination comprising ultra filtered milk, a fat source, and water, wherein said first combination comprises a desired composition of non-fat milk solids of about 5.65% by weight, total solids in a range of about 8.9% to 10.5% by weight, and butterfat in a range of about 1.33% to 2.20% by weight;
a protein source, wherein said protein source comprises whey protein concentrate-80 in a range of about 0.5% to about 1% by weight and calcium caseinate in a range of about 0.5% to about 1% by weight;
a predetermined amount of gelatin; and
a predetermined amount of live and active cultures.

65. The cultured dairy product of claim 64, wherein said predetermined amount of live and active cultures results in a concentration of 100 million cultures per gram of said cultured dairy product.

66. The cultured dairy product of claim 65, wherein said predetermined amount of live and active cultures results in a concentration of 0.1268 gms/L of said cultured dairy product.

67. A reduced fat cultured dairy product comprising:
a first combination comprising ultra filtered skim milk, a fat source, and water, wherein said fat source provides fat in a range of about 1.33% to about 2.20% by weight;
at least one protein source in a range of about 1% to about 2% by weight;
a predetermined amount of salt; a stabilizer; and
a predetermined amount of live and active cultures.

68. The cultured dairy product of claim 67, wherein said first combination comprises a desired composition of non-fat milk solids of about 5.65% by weight, total solids in a range of about 8.9% to about 10.5% by weight, and butterfat.

69. The cultured dairy product of claim 67, wherein said protein source comprises whey protein concentrate-80 in a range of about 0.5% to about 1% by weight and calcium caseinate in a range of about 0.5% to about 1% by weight.

70. The cultured dairy product of claim 67, wherein said fat source is cream.

71. The cultured dairy product of claim 67, wherein said stabilizer is calcium fortified ice cream stabilizer in an amount of about 0.13% by weight.

72. A cultured dairy product comprising:
a first combination comprising ultra filtered skim milk, a fat source, and water, wherein said first combination comprises a desired composition of non-fat milk solids of about 5.65% by weight, total solids in a range of about 8.9% to about 10.5% by weight, and butterfat to range of about 1.33% to about 2.20% by weight;
a plurality of protein sources comprising whey protein concentrate-80 in a range of about 0.5% to about 1% by weight and calcium caseinate in a range of about 0.5% to about 1% by weight;
a predetermined amount of salt;
a predetermined amount of stabilizer; and
a predetermined amount of live and active cultures.

80. A cultured dairy product in an amount of about 3,785.41 liters comprising:
a first combination comprising about 1,270.91 kg of ultra filtered skim milk, about 181.15 kg of cream, and about 2,270.19 kg of water;
a protein source comprising about 29.11 kg of whey protein concentrate-80 and about 31.99 kg of calcium caseinate;
about 5.09 kg of CC-323 calcium fortifier;
about 5.92 kg of salt;
about 87.34 kg of a stabilizer; and
about 0.50 kg of live and active cultures.
